(19) United States
(12) Patent Application Publication
(10) Pub. No.: US 2025/0144838 A1
(43) Pub. Date: May 8, 2025

(54) A STOP UNIT, ELECTRICAL TOOL DEVICE AND A METHOD

(71) Applicant: Festool GmbH, Wendlingen (DE)

(72) Inventors: Sibylle RAPP, Eislingen (DE); Andreas WELKER, Nürtingen (DE); David MESSER, Zell unter Aichelberg (DE); Philipp EISENMANN, Bissingen (DE)

(21) Appl. No.: 18/835,923

(22) PCT Filed: Feb. 2, 2023
(86) PCT No.: PCT/EP2023/052563

§ 371 Date: Aug. 5, 2024

(30) Foreign Application Priority Data
Feb. 4, 2022 (DE) 10 2022 201 209.7

(51) Int. Cl. B27B 27/02

(52) U.S. Cl. CPC B27B 27/02

(57) ABSTRACT

A stop unit including a stop body extending in the longitudinal direction; and a fastening device having a first fastening mechanism and a second fastening mechanism for fastening the stop unit to an electric tool and which are arranged spaced apart from one another in the longitudinal direction. The stop unit further includes an operating element, which is coupled to the first fastening mechanism and the second fastening mechanism and can be made to perform a first operating-element movement, by means of which the fastening device can be sequentially shifted first into a first fastening state and then into a second fastening state, in which in the first fastening state the first fastening mechanism is in its fastening position and the second fastening mechanism is in a release position, and in which in the second fastening state the first and the second fastening mechanism are in the relevant fastening position.

The invention relates to a stop unit for guiding a workpiece, comprising a stop body which extends in the longitudinal direction of the stop unit, as well as a fastening device with a first fastening mechanism and a second fastening mechanism, said fastening mechanisms being able to be brought into a respective fastening position, in order to fasten the stop unit to an electrical tool, in particular to a saw unit, and being arranged distanced to one another in the longitudinal direction. The stop unit is for example a parallel stop for a bench saw.

According to a conventional embodiment, the two fastening mechanisms are decoupled from one another and are actuated separately from one another by a respective operating lever, in order to effect a clamping of the fastening mechanisms on the electrical tool.

According to a further conventional embodiment, the two fastening mechanisms are coupled to one another via a connection rod and are simultaneously actuated by a single operating lever, so that both fastening mechanisms are simultaneously clamped onto the electrical tool.

An object of the invention lies in providing a stop unit which is simple to operate and with which a reliable operation of the electrical tool can be rendered possible.

The object is achieved by a stop unit according to claim 1. The stop unit comprises an operating element which is coupled to the first fastening mechanism and to the second fastening mechanism and which can be brought into a first operating element movement, by way of which the fastening device can sequentially firstly be brought into a first fastening state and subsequently into a second fastening state, wherein in the first fastening state the first fastening mechanism is situated in its fastening position and the second fastening mechanism is situated in a release position and wherein in the second fastening state the first and the second fastening mechanism are situated in the respective fastening position.

The fastening device thus by way of the operating element movement sequentially firstly assumes the first fastening state and then the second fastening state. In the first fastening state, expediently it is only the first fastening mechanism which provides a clamping to the electrical tool, whereas the second fastening mechanism expediently does not yet provide a clamping to the electrical tool. Thus before both fastening mechanisms provide a respective fastening, in particular clamping, to the electrical tool, one firstly goes through a first state—the first fastening state—in which only the first fastening mechanism provides the fastening, in particular clamping, to the electrical tool.

Due to the fact that the first fastening state is firstly gone through, it is simpler to ensure that the stop unit assumes a predefined stop unit alignment relative to a tool of the electrical tool, in particular relative to a feed direction and/or to a cutting direction of the tool. Preferably, the first fastening mechanism is designed, on assumption of the first fastening position, to effect the stop unit assuming the predefined stop unit alignment. Due to the fact that the second fastening mechanism does not assume the second fastening position until the first fastening mechanism is already situated in the first fastening position, one can reduce or rule out the risk of the second fastening position, in particular a clamping which is effected by the second fastening mechanism compromising the stop unit alignment relative to the tool, said stop unit alignment to be effected by the first fastening mechanism. On account of the sequential assumption of the first fastening state and of the second fastening state, a correct stop unit alignment and thus a more reliable operation is therefore made possible. The two fastening states are effected by way of a single operating element and a single operating movement, in particular a single rotation moment of the operating element. The stop unit is therefore simple to operate.

Advantageous further developments are the subject-matter of the dependent claims.

The invention further relates to an electrical tool device, in particular saw device, comprising an electrical tool, in particular a saw unit, as well as the stop unit.

The invention further relates to a method for operating the electrical tool device, comprising the step: bringing the operating element into the first operating element movement, in order to sequentially bring the fastening device firstly into the first fastening state and subsequently into the second fastening state.

Further exemplary details as well as exemplary embodiments are explained hereinafter with reference to the figures. Herein are shown in

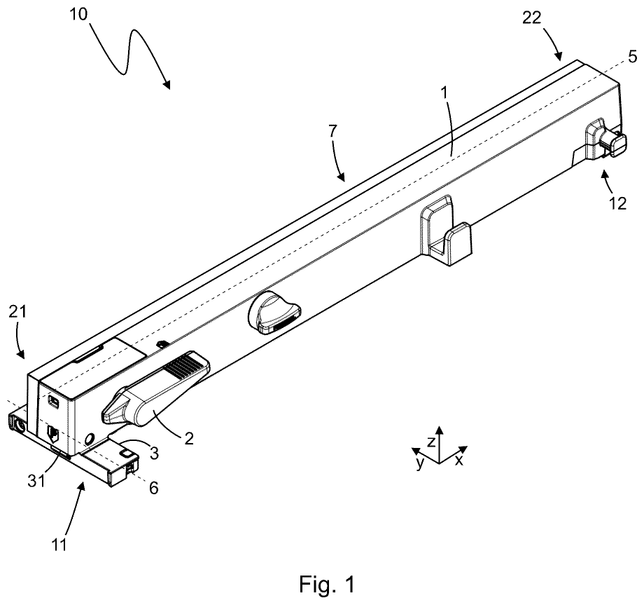

FIG. 1 a perspective representation of a stop unit,

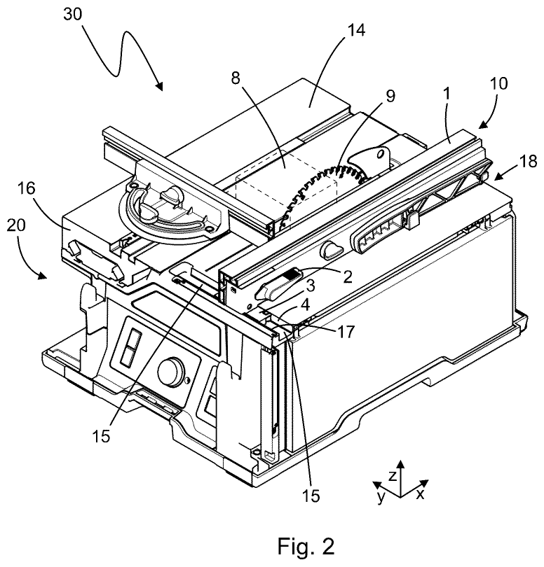

FIG. 2 a perspective representation of an electrical tool device,

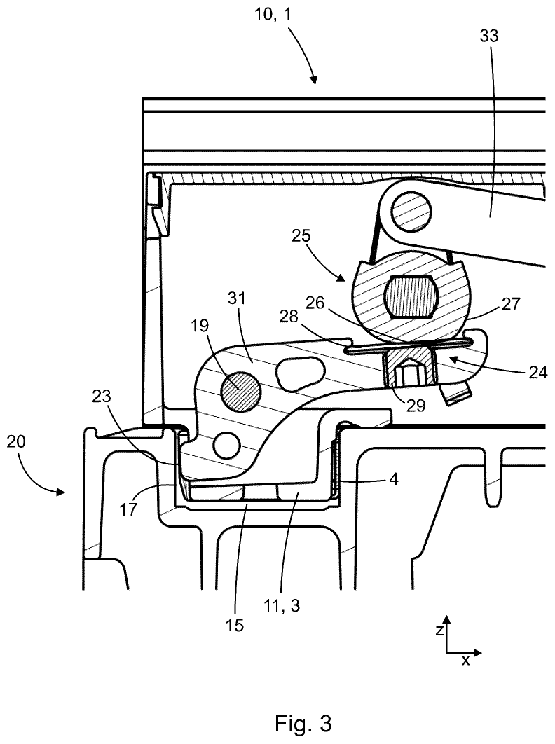

FIG. 3 a sectioned view of a first fastening mechanism,

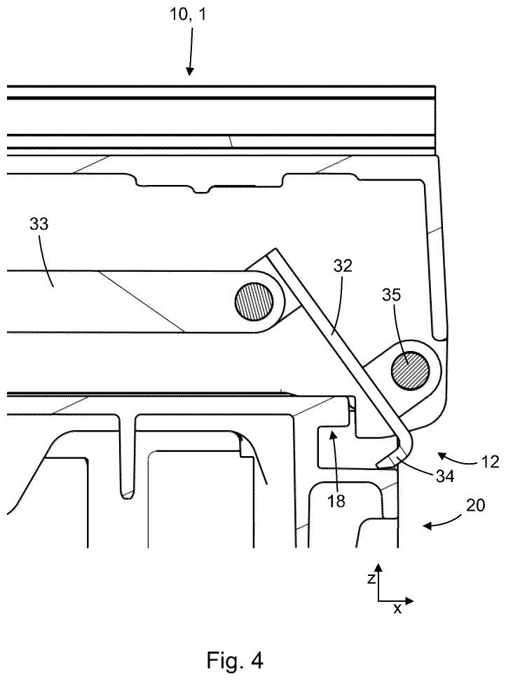

FIG. 4 a sectioned view of a second fastening mechanism,

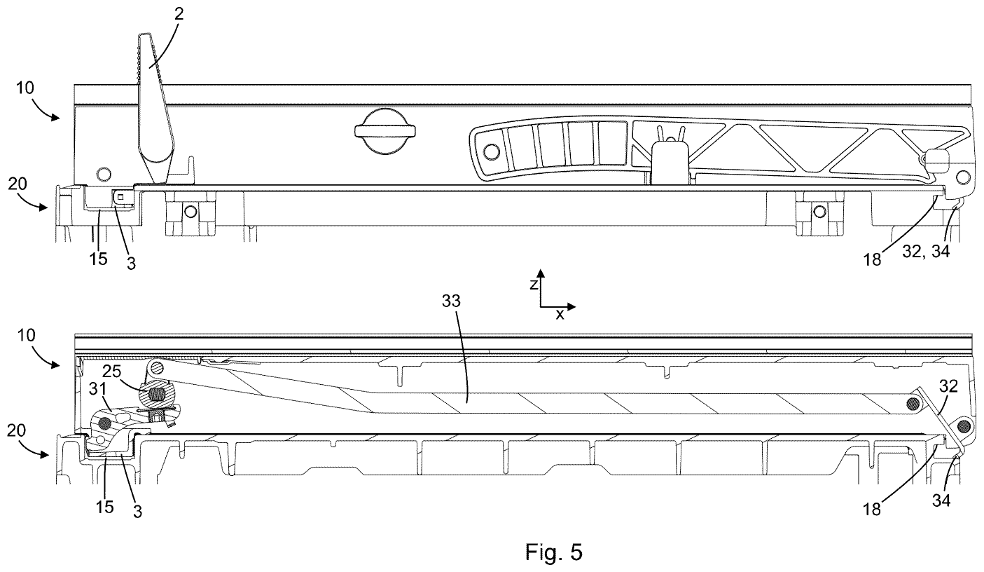

FIG. 5 a lateral view and a sectioned view of the stop unit in a release state,

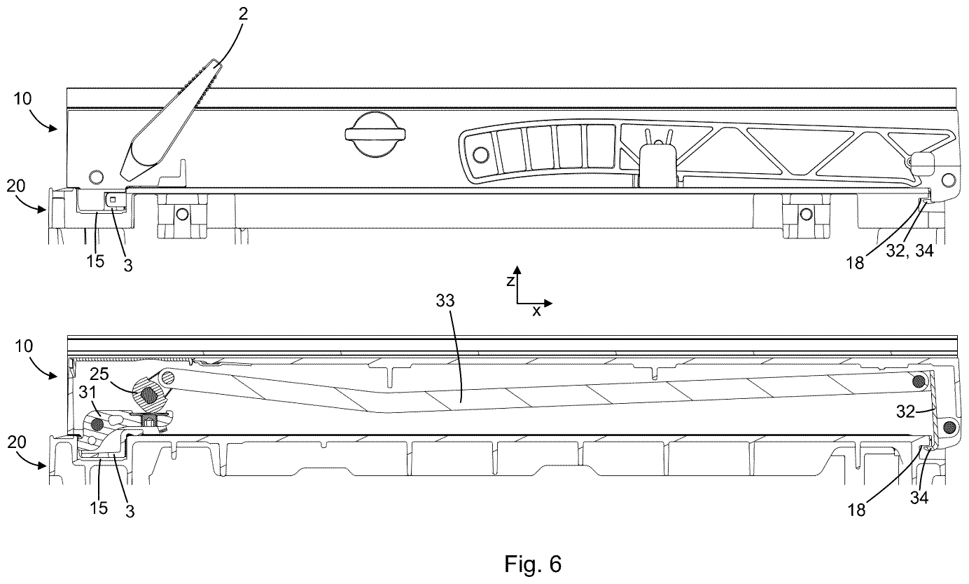

FIG. 6 a lateral view and a sectioned view of the stop unit in a first fastening state,

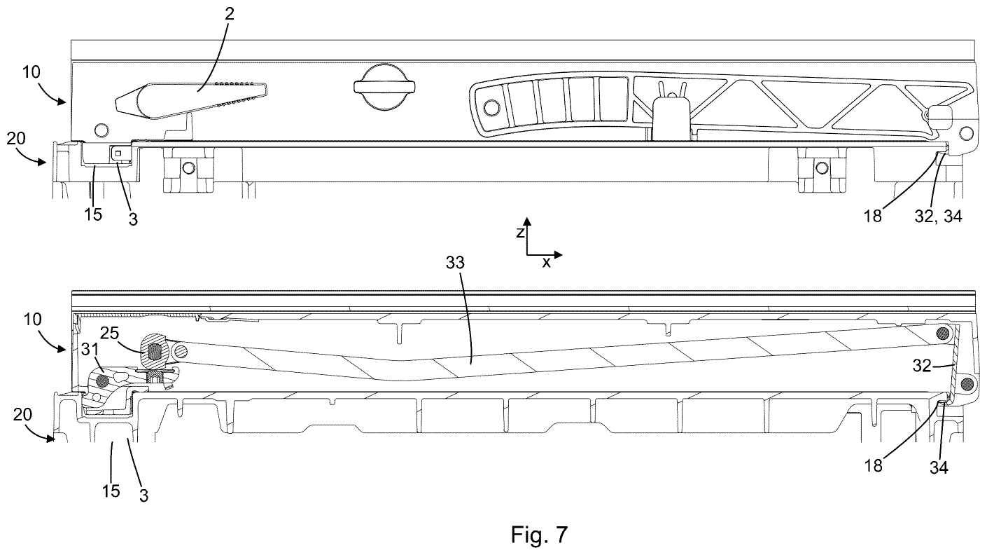

FIG. 7 a lateral view and a sectioned view of the stop unit in a second fastening state,

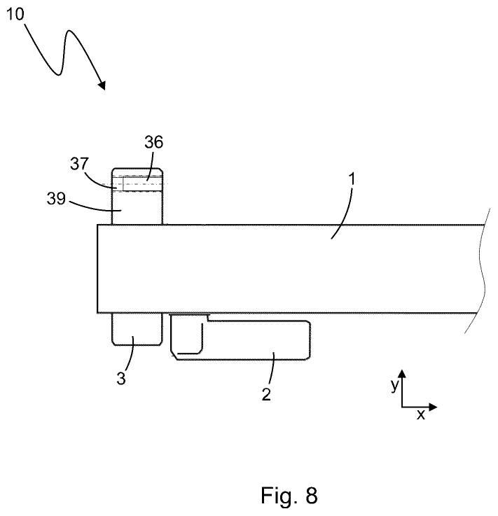

FIG. 8 a schematic view of a first axial end of the stop unit from above, and

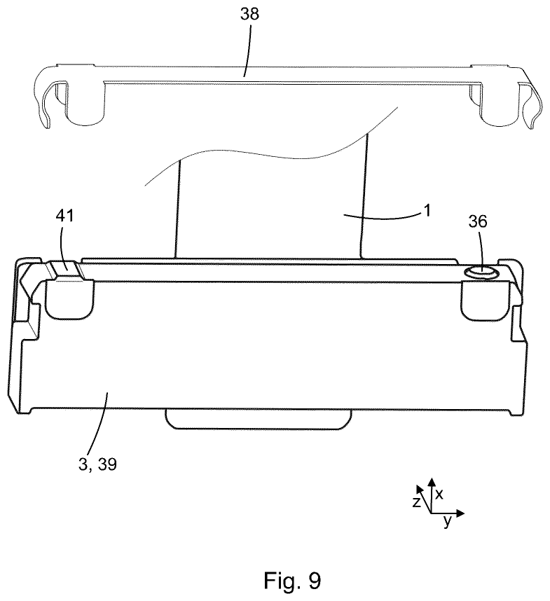

FIG. 9 a schematic view of the first axial end from below.

The directions x-direction, y-direction and z-direction which are drawn in the figures and are aligned orthogonally to one another are referred to hereinafter in the following explanations. The x-direction and the y-direction are horizontal directions and the z-direction is a vertical direction.

FIG. 1 shows a stop unit 10. The stop unit 10 in particular is designed as a longitudinal stop and can be denoted as a parallel stop. The stop unit 10 serves for guiding a workpiece 8. The stop unit 10 can be fastened onto an electrical tool 20, in particular a saw unit, preferably a bench saw. The stop unit 10 defines a guide axis, along which the workpiece 8 can be led.

The stop unit 10 comprises a stop body 1 which extends in a longitudinal direction of the stop unit 10. The longitudinal direction by way of example is aligned in the x-direction. The stop unit 10, in particular the stop body 1 extends along a longitudinal axis 5 which is aligned in the longitudinal direction.

The stop body 1 is preferably designed in a bar-like manner. By way of example, the stop body 1 is cuboid. The stop body 1 comprises a stop surface 7, along which the workpiece can be guided. The stop surface 7 is expediently aligned vertically, in particular normally to the y-direction. The stop surface 7 is arranged on a first longitudinal side of the stop body 1. Expediently, the stop surface 7 defines the guide axis.

The stop unit 10 further comprises a fastening device. The fastening device comprises a first fastening mechanism 11 and a second fastening mechanism 12. An exemplary design of the first fastening mechanism 11 is shown in FIG. 3 and an exemplary design of the second fastening mechanism 12 is shown in FIG. 4.

The first fastening mechanism 11 and the second fastening mechanism 12 can be brought into a respective fastening position, in order to fasten the stop unit 10 to the electrical tool 20, in particular to the saw unit. The fastening position of the first fastening mechanism 11 is also to be denoted as the first fastening position and the fastening position of the second fastening mechanism is also to be denoted as the second fastening position. The first fastening mechanism and the second fastening mechanism are designed as respective clamping mechanisms. In the first fastening position the first fastening mechanism provides a clamping to the electrical tool 20 and in the second fastening position the second fastening mechanism provides a clamping to the electrical tool.

The first fastening mechanism 11 and the second fastening mechanism 12 can be brought into a respective release position, in order to release the fastening of the stop unit 10 to the electrical tool 20. The release position of the first fastening mechanism 11 is also to be denoted as the first release position and the release position of the second fastening mechanism is also to be denoted as the second release position. In the first release position the first fastening mechanism provides no clamping to the electrical tool 20 and in the second release position the second fastening mechanism provides no clamping to the electrical tool.

The first fastening mechanism 11 and the second fastening mechanism 12 are arranged distanced to one another in the longitudinal direction. The first fastening mechanism 11 is preferably arranged at a first axial end 21 of the stop body and/or the second fastening mechanism 12 is arranged at a second axial end 21 of the stop body 1. In particular, the first fastening mechanism 11 and/or the second fastening mechanism 12 are arranged on the lower side of the stop body 1.

The stop unit 10 further comprises an operating element 2. The operating element 2 by way of example is arranged on the stop body 1, in particular on a second longitudinal side of the stop body 1. The second longitudinal side is aligned opposite to the first longitudinal side—by way of example normally to the negative y-direction. By way of example, the operating element 2 is designed as an operating lever. The operating element 2 is movably, in particularly rotationally movably mounted on the stop body 1. The operating element 2 is coupled to the first fastening mechanism 11 and to the second fastening mechanism 12 and specifically expediently via a coupling mechanism which is preferably arranged in the stop body 1.

The operating element 2 can be brought into a first operating element movement, in particular manually by the user. Expediently, the operating element can be gripped and moved by hand by the user, in order to bring it into the first operating element movement. The first operating element movement by way of example is a first rotation movement in a first rotation direction, by way of example in the clockwise direction (in an x-z view). On account of the first operating element movement, the fastening device can be sequentially brought firstly into a first fastening state and subsequently into a second fastening state. The first fastening state is shown in FIG. 6 and the second fastening state is shown in FIG. 7. In the first fastening state, the first fastening mechanism 11 is situated in its fastening position—thus in the first fastening position—and the second fastening mechanism 12 is situated in its release position. In the second fastening state, the first and the second fastening mechanism 11, 12 are situated in the respective fastening position—i.e. the first fastening mechanism is situated in the first fastening position and the second fastening mechanism is situated in the second fastening position.

In particular, starting from a release state, the fastening device can be brought into the second fastening state via the first fastening state by way of the first operating element movement. The release state is shown in FIG. 5. In the release state, the first and the second fastening mechanism 11, 12 are situated in the respective release position—i.e. the first fastening mechanism is situated in the first release position and the second fastening mechanism is situated in the second release position.

In a state in which it is attached to the electrical tool 20, the stop unit 10 cannot be removed from the electrical tool 20 in the first fastening state and/or the second fastening state. In the release state, the stop unit 10 can be removed from the electrical tool 20.

The operating element 2 can further be brought into a second operating element movement which is expediently opposite to the first operating element movement. The second operating element movement by way of example is a second rotation movement in a second rotation direction, by way of example in the anti-clockwise direction (in an x-z view). Starting from the second fastening state, the fastening device can be brought into the release state, in particular via the first fastening state, by way of the second operating element movement.

The first fastening mechanism 11 comprises an alignment section 3. The alignment section 3 extends along an alignment section longitudinal axis 6. The alignment section longitudinal axis 6 is aligned orthogonally to the longitudinal axis 5 of the stop unit 1. Expediently, the alignment section longitudinal axis 6 is aligned in the y-direction. The alignment section 3 by way of example is designed in a cuboid manner and is expediently arranged on the lower side of the stop body 1 at the first axial end 21. The y-extension of the alignment section 3 is preferably larger than the y-extension of the stop body 1. By way of example, the alignment section 3 projects beyond the stop body 1 at both sides with respect to the y-axis.

The alignment section 3 can be applied onto a reference section 4 of the electrical tool 20, in order in the first fastening state to bring the stop unit 10 with its longitudinal axis which runs in the longitudinal direction into a predefined stop unit alignment relative to the electrical tool, so that the stop unit is already situated in the predefined stop unit alignment given an assumption of the second fastening state which sequentially follows the first fastening state. Expediently, the stop unit alignment is already definitively fixed in the first fastening state by way of the alignment section 3 and the assumption of the second fastening state—in particular the assumption of the second fastening position—no longer changes the stop unit alignment.

Preferably, in the predefined stop unit alignment, the guide axis of the stop unit 10 is aligned relative to a machining axis, in particular to a cutting axis, of the electrical tool 20, such that the guide axis and the cutting axis distance themselves from one another (this in particular diverge) in the feed direction (of a workpiece 8 onto a tool 9 of the electrical tool 20), or that the guide axis and the cutting axis run parallel to one another. The risk of a kickback can be reduced by way of such a stop unit alignment.

FIG. 2 shows an electrical tool device 30 which by way of example is designed as a saw device. The electrical tool device 30 comprises the electrical tool 20 which by way of example is designed as a saw unit. The electrical tool device 30 further comprises the stop unit 10.

The stop unit 1 is shown in FIG. 2 in the state in which it is attached to the electrical tool 20. Expediently, the stop unit 1 (in particular by way of releasing the first fastening mechanism 11 and the second fastening mechanism 12) can be completely removed from the electrical tool 20.

The electrical tool 20 comprises a workpiece rest 14 which in particular is designed as a workpiece rest surface. The workpiece rest 14 is aligned normally to the z-direction in a designated alignment of the electrical tool 20. By way of example, the stop unit 10 (in the state in which it is attached to the electrical tool) is arranged on the workpiece rest 14. By way of example, the stop unit 10 extends over at least 80% of the x-direction of the workpiece rest 14 and/or of the electrical tool 20.

The electrical tool 20 comprises a tool 9 which by way of example is designed as a saw blade. The tool 9 by way of example defines a feed direction which is aligned in the x-direction and in which the workpiece 8 is to be pushed onto the tool 9, in order to machine the workpiece with the tool 9. By way of example, the tool 9 projects upwards out of the workpiece rest 14. The tool 9 defines the cutting direction (which in particular is aligned in the x-direction) and the cutting axis which is aligned in the cutting direction.

The electrical tool 20 expediently comprises a support structure 16 which by way of example has a cuboid basic shape. The upper side of the support structure 16 by way of example provides a workpiece rest 14. By way of example, the electrical tool 20 stands with the lower side of the support structure 16 on a base surface, for example a work table or a workbench, in particular in a stationary manner, on machining the workpiece 8 with the tool 9.

The electrical tool 20 is designed for example as a mobile or as a semi-stationary electrical tool 20. Expediently, the electrical tool 20 can be carried by a single person.

The stop unit 10 is expediently designed as a parallel stop. In the state in which it is attached to the electrical tool 20, the stop unit 10 is aligned with its longitudinal direction in the feed direction in which the workpiece 8 is to be pushed onto the tool 9 of the electrical tool 20, in order to machine the workpiece 8 with the tool 9. The stop unit 10 with its stop side 7 faces the tool 9. In particular, the stop unit 10 in the state in which it is attached to the electrical tool 20 is arranged laterally next to the tool 9, in particular laterally next to the cutting axis of the tool 9.

The electrical tool 20 preferably comprises a first fastening section 17 and/or a reference section 4, to which the stop unit 1 (in the first fastening state and in the second fastening state) is fastened by the first fastening mechanism 11 when the stop unit 1 is situated in the state in which it is attached to the electrical tool 20. By way of example, the first fastening mechanism 11 is clamped between the first fastening section and the reference section 4. By way of example, the first fastening section 17 is a first contact surface which in particular is aligned perpendicularly, for the first fastening mechanism 11 and/or the reference section 4 is a second contact surface which in particular is aligned perpendicularly, for the first fastening mechanism 11.

The first fastening section 17 and/or the reference section 4 by way of example is arranged in a front (in particular with reference to the x-direction) edge region of the workpiece rest 14.

Preferably, the electrical tool 20 comprises a fastening groove 15 which by way of example provides the first fastening section 17 and the reference section 4. The fastening groove 15 in particular is arranged on the upper side of the support structure 16, in particular in the workpiece rest 14. The fastening groove 15 by way of example runs in the y-direction and preferably extends over at least 30% of the y-extension of the workpiece rest 14 and/or of the electrical tool 20. The fastening groove 15 by way of example is arranged in a front edge region of the workpiece rest 14. In the state in which the stop unit 10 is attached to the electrical tool 20, the alignment section 3 is inserted into the fastening groove 15.

The fastening groove 15 comprises a first groove inner side which provides the first fastening section 17. The first groove inner side by way of example is aligned normally to the positive x-direction. The fastening groove 15 comprises a second groove inner side which lies opposite the first groove inner side and which provides the reference section 4.

The electrical tool 20 further comprises a second fastening section 18, to which the stop unit 1 (in the second fastening state) is fastened by the second fastening mechanism 12 when the stop unit 1 is situated in the state in which it is attached to the electrical tool 20. By way of example, the second fastening mechanism 12 is clamped onto the second fastening section 12. By way of example, the second fastening section 18 is an in particular horizontally aligned contact surface for the second fastening mechanism 12. The second fastening section 18 by way of example is arranged in a rear (in particular with respect to the x-direction) region—in particular on the rear (with respect to the x-direction) end—of the workpiece rest 14 and/or of the electrical tool 20.

FIG. 3 shows a sectioned representation of the first fastening mechanism 1 in a state in which the alignment section 4 is inserted into the fastening groove 15 and the first fastening mechanism 11 is situated in the first release position. In the first release position, the first fastening mechanism 11 provides no fastening (in particular no vertical fastening and/or no fastening which is effective in the y-direction) of the stop unit 1 to the electrical tool 20.

The first fastening mechanism 11 comprises a first fastening element 31. The first fastening element 31 can be brought into a first fastening element movement relative to the alignment section by way of the first operating element movement, in order to assume the first fastening position and thus to be brought into engagement with the first fastening section 17 of the electrical tool 20.

In the first fastening position of the first fastening mechanism 11, the first fastening element 31 presses the first fastening element 31 against the first fastening section 17—by way of example against the first groove inner side—and the alignment section 3 presses against the reference section 4—by way of example against the second groove inner side—in order to thus provide a clamping fastening of the stop unit 1 to the electrical tool 20.

The reference section 4 has a defined alignment with respect to the cutting axis of the tool 9, so that the predefined stop unit alignment is achieved by way of the alignment section 3 bearing on the reference section 4.

The first fastening element 31 by way of example is mounted in a pivotably movable manner relative to the stop body 1, in particular about a first fastening element pivot axis 19 which is aligned in the y-direction. The first fastening element movement in particular is a pivoting movement.

The first fastening element 31 comprises a first clamping section 23 which in the first fastening position projects out of the alignment section 3, in particular in the negative x-direction, in order to press against the first fastening section 17. The first clamping section 23 is located below the stop body 1. The first clamping section 23 is located in the fastening groove 15 in a state in which the stop unit 10 is attached to the electrical tool 20.

The first fastening element 3 comprises a coupling section 24 which is coupled to the operating element 2 via the coupling mechanism. By way of example, the coupling section 24 is arranged in the stop body 1.

The coupling mechanism of the stop unit 10 by way of example comprises a first coupling element 25 which in particular is designed as an eccentric element and which couples the operating element 2 to the first fastening element 31, so that the first operating element movement is converted into the first fastening element movement. Expediently, the first coupling element 25 is coupled to the operating element 2, in particular fastened to this, in a rotationally fixed manner. The first coupling element 25 is rotatably mounted relative to the stop body 1 about a rotation axis (by way of example the rotation axis of the operating element 2). The first coupling element 25 lies on the coupling section 24. The first coupling element 25 comprises a first outer contour region 26 and a second outer contour region 27. By way of example, the first outer contour region 265 and the second outer contour region 27 are regions of the outer contour of the first coupling element 25 in an x-z section. The radius (with respect to the rotation axis of the first coupling element 25) of the first outer contour region 26 is expediently smaller than the radius (with respect to the rotation axis of the first coupling element 25) of the second outer contour region 27. The radius of the second outer contour region 27 is preferably constant.

In a first rotary position region of the operating element 2, the first coupling element 25 with the first outer contour region 26 lies on the coupling section 24 and by way of this permits the first release position of the first fastening element 31 (and in particular the release state of the fastening device). A second rotary position region follows the first rotary position region and a third rotary position region follows the second rotary position region. In the second rotary position region and the third rotary position region of the operating element 2, the first coupling element 25 with the second outer contour region 26 lies on the coupling section 24 and by way of this effects the first fastening position of the first fastening element 31. By way of example, the coupling section 24 in the second rotary position region and in the third rotary position region is pressed further downwards than in the first rotary position region.

The coupling section 24 by way of example comprises a spring plate 28. Expediently, the first coupling element 25 lies on the spring plate 28. The spring plate 28 is preferably supported on the stop body 1 and by way of this exerts a spring force upon the fastening element 31, said force forcing the fastening element 31 into the release position.

Optionally, the coupling section 24 comprises a clamping force adjustment element 29 which by way of example is designed as a threaded pin. The clamping force of the first fastening mechanism 11 can be set via the clamping force adjustment element 29. The clamping force adjustment element 29 by way of example is arranged on the side of the spring plate 28 which is away from the first coupling element 29 and presses the spring plate 28 in the direction of the coupling element 25.

The coupling mechanism of the stop unit 10 further comprises a second coupling element 33 which by way of example is designed as a coupling rod. The second coupling element 33 couples the operating element 2 to the second fastening mechanism 12. The second coupling element 33 converts the first operating element movement (designed as a rotary movement) into a movement with a linear movement component (in particular in the x-direction). The second coupling element 33 by way of example is coupled to the operating element 2, in particular fastened to this, in a rotationally movable manner and/or in a manner radially distanced to the rotation axis of the operating element 2, so that the first operating element movement effects the movement of the second coupling element 33 with the linear movement component. The second coupling element 33 by way of example extends over at least 60% or at least 70% of the longitudinal extension of the stop unit 10. The second coupling element 33 is arranged in the stop body 1, in particular in a complete manner.

FIG. 4 shows a sectioned representation of the second fastening mechanism 12 in a state in which the stop unit 10 is attached to the electrical tool 20 and the second fastening mechanism 12 is situated in the second release position. In the second release position, the second fastening element 12 provides no fastening (in particular no vertical fastening and/or no fastening which is effective in the y-direction) of the stop unit 1 to the electrical tool 20.

The second fastening mechanism 12 comprises a second fastening element 32 which by way of example is designed as a hook element. The second fastening element 32 can be brought into a second fastening element movement by way of the first operating element movement, in order to assume the second fastening position and thus to be brought into engagement with the second fastening section 18 of the electrical tool 20.

The second fastening element 32 is preferably more elastic than the first fastening element 31.

In the second fastening position of the second fastening mechanism 11, the second fastening element 32 is pulled against the second fastening section 18, in order to thus provide a clamping fastening of the stop unit 10 to the electrical tool 20. By way of example, in the second fastening position a clamping projection of the electrical tool 20 is clamped between the second fastening element 32 and the lower side of the stop body 1.

The second fastening element 32 by way of example is mounted in a pivotably movable manner relative to the stop body 1, in particular about a second fastening element pivot axis 35 which is aligned in the y-direction. The second fastening element movement in particular is a pivoting movement.

The second fastening element 32 comprises a second clamping section 34 which in particular is designed as a hook section and preferably in the second fastening position presses against the second fastening section 18.

The second fastening element 32 is coupled to the operating element 2 via the coupling mechanism, in particular the second coupling element 33.

The second coupling element 33 by way of example is coupled to the second fastening element 32, in particular fastened to this, in a rotationally movable manner and/or in a manner radially distanced to the second fastening element pivot axis 35. The linear movement component of the second coupling element 33 which is effected by the first operating element movement effects the second fastening element movement, by way of example the pivoting movement about the second fastening element pivot axis 35.

In the first rotary position region of the operating element 2 (and preferably in the second rotary position region), the second fastening element 32, in particular the second clamping section 34 is not in engagement with the second fastening section 18 and is thus located in the second release position.

In the third rotary position region of the operating element 2, the second fastening element 32, in particular the second clamping section 34 is in engagement with the second fastening section 18 and is thus situated in the second fastening position.

FIGS. 5 to 7 show the various states which the fastening device of the stop unit 10 runs through when the operating element 2 is brought into the first operating element movement.

The release state is shown in FIG. 5, in which the stop unit 10 can be removed from the electrical tool, for example by way of a user gripping the stop unit 10 and lifting it upwards. In the release state, the first fastening mechanism 11, in particular the first fastening element 31 is situated in the first release position. In the release state, the second fastening mechanism 12, in particular the second fastening element 32 is situated in the second release position. Expediently, in the release state the stop unit 10 (in particular with the alignment section 3 which is inserted in the fastening groove 15) can be positioned relative to the tool 9 and/or to the workpiece rest 14 in the y-direction, in particular in a free, preferably infinite manner.

The alignment of the stop unit 10 relative to the tool 9, in particular of the guide axis relative to the cutting axis is preferably not fixed in the release state. Expediently, in the release state the guide axis can be moved, in particular pivoted, relative to the cutting axis, expediently in a horizontal plane—thus in an x-y plane.

The release state by way of example is effected by way of the operating element 2 being situated in the first rotary position region. By way of example, the operating element 2 is aligned perpendicular upwards in the first rotary position region.

The first fastening state is shown in FIG. 6. In the first fastening state, the first fastening mechanism 11, in particular the first fastening element 31 is situated in the first fastening position. In the first fastening state, the second fastening mechanism, 12, in particular the second fastening element 32 is situated in the second release position.

Preferably, the stop unit 10 in the first fastening state is fixedly fixed to the electrical tool 20 in all spatial directions by way of the first fastening mechanism 11. Expediently, in the first fastening state, the alignment of the stop unit 10 relative to the tool 9, in particular of the guide axis relative to the cutting axis is fixed and expediently cannot be changed.

The first fastening state by way of example is effected by way of the operating element 2 being situated in the second rotary position region. By way of example, the operating element 2 is aligned diagonally upwards in the second rotary position region.

The transition from the release state to the first fastening state is effected in a first operating element movement phase of the first operating element movement.

The first operating element movement includes the first operating element movement phase which effects the first fastening element movement of the first fastening element 31 of the first fastening mechanism 11. The first fastening element 31 (in the first operating element movement) is pressed against the first fastening section 17 of the electrical tool 20 due to the first fastening element movement, in order to create the first fastening state. The first fastening element movement is effected relative to the alignment section 3. If the first fastening element 31 bears on the first fastening section 17, the first fastening element movement has the effect of the alignment section 3 being pressed against the reference section 4, by which means the stop unit 10 with its longitudinal axis 5 is expediently brought into the predefined stop unit alignment relative to the tool 9, in particular to the cutting axis.

The second fastening state is shown in FIG. 7. In the second fastening state, the first fastening mechanism 11, in particular the first fastening element 31 is situated in the first fastening position. In the second fastening state, the second fastening mechanism 12, in particular the second fastening element 32 is situated in the second fastening position.

Preferably, the stop unit 10 in the second fastening state is fixedly fixed to the electrical tool 20 in all spatial directions by way of the first and second fastening mechanism 11, 12. Expediently, in the second fastening state, the alignment of the stop unit 10 relative to the tool 9, in particular of the guide axis relative to the cutting axis is fixed and expediently cannot be changed.

The second fastening state by way of example is effected by way of the operating element 2 being situated in the third rotary position region. By way of example, the operating element 2 is aligned horizontally in the third rotary position region.

The transition from the first fastening state to the second fastening state is effected in a second operating element movement phase of the first operating element movement. Expediently, on transition from the first fastening state to the second fastening state, the stop unit alignment, thus the alignment of the stop unit 10 relative to the tool 9, in particular of the guide axis relative to the cutting axis, is not changed.

The operating element movement includes the second operating element movement phase which is subsequent to the first operating element movement phase and which has the effect of the second fastening element 32 of the second fastening mechanism 12 being brought into engagement with the second fastening section 18 of the electrical tool 20, in order to create the second fastening state.

Preferably, the second fastening element 32 (by way of the first operating element movement) is not brought into engagement with the second fastening section 18 until the first fastening element movement is completed.

Preferably, no movement of the first fastening element 31 is effected in the second operating element movement phase. In particular, the first fastening element movement is already completed at the beginning of the second operating element movement phase. By way of example, the first coupling element 25 with the second outer contour region 27 rolls over the coupling section 24 in the second operating element movement phase. The second outer contour region 27 has a constant radius (with respect to the rotation axis of the first coupling element 25) so that the first coupling element 25 in the second operating element movement phase effects no movement of the first fastening element 31.

FIG. 8 shows the first axial end 21 of the stop unit 10.

By way of example, the alignment section 3 comprises an alignment adjustment element 36 via which the predefined stop unit alignment can be set. The alignment adjustment element 36 by way of example is a threaded pin. Expediently, the alignment section 3 comprises a through-hole which in particular runs in the x-direction and in which the alignment adjustment element 36 is arranged. The alignment section 3 comprises an alignment section body 39, in which the through-hole is arranged and/or relative to which the alignment adjustment element 36 can be adjusted, in particular in the x-direction.

FIG. 9 shows the first axial end 21 of the stop unit 10 from below. The alignment section 3 by way of example defines two contact points with which the alignment section 3 can be applied onto the reference section 4, in order to achieve the predefined stop unit alignment. By way of example, a first contact point is defined by a first projection (in particular projecting in the x-direction) of the alignment section body 39. Expediently, a second contact point is defined by the alignment adjustment element 36. The alignment section 3 preferably comprises a clamping plate 38 which is expediently fastened to the alignment section body 39 and with which the alignment section 3 can be applied onto the reference section 4, in order to achieve the predefined stop unit alignment. The clamping plate 38 expediently lies on the first projection 41 and/or on the alignment adjustment element 36, by which means both contact points are defined.

Optionally, the electrical tool 20 comprises a position display, for example a scale, for the display of a position of the stop unit 10 relative to the electrical tool 20 in a direction orthogonally to the longitudinal direction. The user can adjust the stop unit 10 in the y-direction to a certain position via the position display.

The electrical tool device 30 can be operated with a method which comprises the step: bringing the operating element into the first operating element movement, in order to sequentially bring the fastening device firstly into the fastening state and subsequently into the second fastening state.

1-16. (canceled)

17. A stop unit for guiding a workpiece, comprising a stop body which extends in a longitudinal direction of the stop unit, as well as a fastening device with a first fastening mechanism and a second fastening mechanism, said fastening mechanisms being able to be brought into a respective fastening position, in order to fasten the stop unit to an electrical tool and being arranged distanced to one another in the longitudinal direction, further comprising an operating element which is coupled to the first fastening mechanism and to the second fastening mechanism and which can be brought into a first operating element movement, by way of which first operating element movement the fastening device can sequentially firstly be brought into a first fastening state and subsequently into a second fastening state, wherein in the first fastening state the first fastening mechanism is situated in its fastening position and the second fastening mechanism is situated in a release position and wherein in the second fastening state the first and the second fastening mechanism are situated in the respective fastening position.

18. The stop unit according to claim 17, wherein the first fastening mechanism comprises a first fastening element which by way of the first operating element movement can be brought into a first fastening element movement, in order to assume the first fastening position, and the first fastening mechanism further comprises an alignment section, wherein the first fastening element serves to be pressed, in the fastening position of the first fastening mechanism, against a first groove inner side of a fastening groove of the electrical tool, and the alignment section serves to be pressed, in the fastening position of the first fastening mechanism, against a second groove inner side of the fastening groove, the second groove inner side lying opposite to the first groove inner side, in order to thus provide, by the first fastening element and the alignment section, a clamping fastening in the fastening groove.

19. The stop unit according to claim 17, wherein the first fastening mechanism comprises a first fastening element, the stop unit further comprising a coupling mechanism having a first coupling element which is designed as an eccentric element and which couples the operating element to the first fastening element, so that the first operating element movement is converted into a first fastening element movement.

20. A stop unit for guiding a workpiece, comprising a stop body which extends in a longitudinal direction of the stop unit, as well as a fastening device with a first fastening mechanism and a second fastening mechanism, said fastening mechanisms being able to be brought into a respective fastening position, in order to fasten the stop unit to an electrical tool and being arranged distanced to one another in the longitudinal direction, further comprising an operating element which is coupled to the first fastening mechanism and to the second fastening mechanism and which can be brought into a first operating element movement, by way of which first operating element movement the fastening device can sequentially firstly be brought into a first fastening state and subsequently into a second fastening state, wherein in the first fastening state the first fastening mechanism is situated in its fastening position and the second fastening mechanism is situated in a release position and wherein in the second fastening state the first and the second fastening mechanism are situated in the respective fastening position, wherein the operating element is arranged on a longitudinal side of the stop body.

21. A stop unit for guiding a workpiece, comprising a stop body which extends in a longitudinal direction of the stop unit, as well as a fastening device with a first fastening mechanism and a second fastening mechanism, said fastening mechanisms being able to be brought into a respective fastening position, in order to fasten the stop unit to an electrical tool and being arranged distanced to one another in the longitudinal direction, further comprising an operating element which is coupled to the first fastening mechanism and to the second fastening mechanism and which can be brought into a first operating element movement, by way of which first operating element movement the fastening device can sequentially firstly be brought into a first fastening state and subsequently into a second fastening state, wherein in the first fastening state the first fastening mechanism is situated in its fastening position and the second fastening mechanism is situated in a release position and wherein in the second fastening state the first and the second fastening mechanism are situated in the respective fastening position, wherein the first fastening mechanism comprises a first fastening element, which, via the first operating element movement, can be pressed against the electrical tool in order to establish the first fastening state, wherein the second fastening mechanism comprises a second fastening element, which, via the first operating element movement, can be brought into engagement with the electrical tool in order to establish the second fastening state, wherein the stop unit comprises a coupling mechanism having a coupling element which couples the operating element to the second fastening element, wherein the coupling element is directly coupled to the second fastening element via a joint.

22. The stop unit according to claim 21, wherein the second fastening element is more elastic than the first fastening element.

23. The stop unit according to claim 17, wherein the first fastening mechanism comprises an alignment section which can be applied onto a reference section of the electrical tool, in order to bring, in the first fastening state, the stop unit with its longitudinal axis running in the longitudinal direction into a predefined stop unit alignment relative to the electrical tool, so that when the stop unit assumes the second fastening state which sequentially follows the first fastening state, the stop unit is already situated in the predefined stop unit alignment.

24. The stop unit according to claim 23, wherein the alignment section extends along an alignment section longitudinal axis which is aligned orthogonally to the longitudinal axis of the stop unit.

25. The stop unit according to claim 23, wherein the alignment section comprises an alignment adjustment element, via which the predefined stop unit alignment can be set.

26. The stop unit according to claim 23, wherein the first fastening mechanism comprises a first fastening element which by way of the first operating element movement can be brought into a first fastening element movement, in order to assume the first fastening position, and thus to be brought into engagement with a first fastening section of the electrical tool.

27. The stop unit according to claim 17, wherein the stop body is designed in a bar-shaped.

28. The stop unit according to claim 17, wherein the first fastening mechanism is arranged at a first axial end of the stop body and/or the second fastening mechanism is arranged at a second axial end of the stop body.

29. The stop unit according to claim 17, wherein the operating element is designed as an operating lever and/or the first operating element movement is a first rotation movement in a first rotation direction.

30. An electrical tool device comprising an electrical tool as well as a stop unit according to claim 17.

31. The electrical tool device according to claim 30, wherein the stop unit is designed as a parallel stop and in a state in which it is attached to the electrical tool is arranged laterally next to a tool of the electrical tool.

32. The electrical tool device according to claim 30, wherein the stop unit in the first fastening state is fixedly fixed to the electrical tool in all spatial direction by way of the first fastening mechanism.

33. The electrical tool device according to claim 30, wherein the operating element movement comprises a first operating element movement phase which effects a first fastening element movement of a first fastening element of the first fastening mechanism, wherein the first fastening element is pressed against a first fastening section of the electrical tool by way of the first fastening element movement, in order to create the first fastening state and wherein the operating element movement comprises a second operating element movement phase which follows the first operating element movement phase and which has the effect of a second fastening element of the second fastening mechanism being brought into engagement with a second fastening section of the electrical tool, in order to establish the second fastening state.

34. The electrical tool device according to claim 33, wherein the second fastening element is only brought into engagement with the second fastening section by way of the first operating element movement after the first fastening element movement is completed.

35. The electrical tool device according to claim 30, wherein the electrical tool comprises a fastening groove which comprises a first groove inner side which provides a first fastening section, and a second groove inner side which lies opposite the first groove inner side and which provides a reference section, wherein the first fastening mechanism comprises a first fastening element and an alignment section, wherein in the fastening position of the fastening mechanism the first fastening element presses against the first groove inner side and the alignment section presses against the second groove inner side, in order to thus provide a clamping fastening of the stop unit to the electrical tool.

36. The electrical tool device according to claim 30 further comprising a position display for the display of a position of the stop unit relative to the electrical tool in a direction orthogonal to the longitudinal direction.

37. A method for operating the electrical tool device according to claim 30, comprising the step: bringing the operating element into the first operating element movement, in order to sequentially bring the fastening device firstly into the first fastening state and subsequently into the second fastening state.
